(19) United States
(12) Patent Application Publication
(10) Pub. No.: US 2011/0241615 A1
(43) Pub. Date: Oct. 6, 2011

(54) Adapter capable of wireless charging

(75) Inventor: Ming-Hsiang Yeh, Taipei City (TW)

(73) Assignee: Winharbor Technology Co., Ltd., New Taipei City (TW)

(21) Appl. No.: 13/064,400

(22) Filed: Mar. 23, 2011

(30) Foreign Application Priority Data
Mar. 30, 2010 (TW) 099205514

(51) Int. Cl. H02J 7/00

(52) U.S. Cl. 320/108

(57) ABSTRACT

An adapter capable of wireless charging has a main body including transmitter circuit. An electronic device with a receiver circuit to be charged is positioned on the main body. The transmitter circuit is configured to send an AC signal in a wireless way to the receiver circuit for charging the receiver circuit. Thereby, at least one electronic product can be charged without using its dedicated charger. Also the limitation caused to the practical use of the notebook by wired charging through a charger can be eliminated.

### FIELD OF THE INVENTION

The present invention relates to a charging device, and more particularly to a charging device applicable to adapters and the like.

### BACKGROUND OF THE INVENTION

Recently, with the ongoing improvement of science and technologies, people have required more and more from electronic products, particularly consumer electronics. The ancient, bulky electronic products (such as CD players, telephone sets and desktop computers) have been compacted into portable, efficient electronic products (such as multimedia players (MPEG Audio Layer-3, MP3), mobile phones and notebooks), for allow people to live and work more efficiently.

These electronic products, such as multimedia players and mobile phones, are typically powered by rechargeable batteries such as Ni-MH batteries or lithium cells. Such a rechargeable battery can get charged by a charging device that includes a charging dock and a plug connected in a wired manner. The charging dock has a socket for receiving the rechargeable battery, while the plug is coupled to a power outlet for receiving a voltage or current, thereby charging the battery. On the other hand, a notebook to be powered or recharged has to be connected to a power outlet through an adapter that adapts a power outlet's voltage or current to the notebook. As the foregoing portable electronic products are all powered through adapters or rechargeable batteries, people going out with these portable electronic products have to carry their dedicated adapters or chargers as well, thus being greatly inconvenient. In addition, since the charging devices or adapters as mentioned above charge the rechargeable batteries in a wired manner, such a wired deployment significantly limits the charging operation.

In view of this, the inventor of the present invention has spent contemplation in research, design and fabrication with the attempt to provide an adapter capable of wireless charging that is highly portable with reduced limitation with respect to its charging operation.

### SUMMARY OF THE INVENTION

A primary objective of the present invention is to provide an adapter capable of wireless charging, which allows various electronic products to be charged without their dedicated chargers.

Another objective of the present invention is to provide an adapter capable of wireless charging, which is configured to charge wirelessly so as to eliminate the limitation with respect to its charging operation.

To achieve the above objectives, the disclosed adapter capable of wireless charging is for charging at least one electronic device that has a receiver circuit. The adapter capable of wireless charging comprises a main body coupled with the electronic device, wherein the main body is the adapter and includes a power source; and at least one transmitter circuit deposited on the main body. The power source provides electric power to the transmitter circuit. The electric power is converted into the AC signal by the transmitter circuit. The AC signal is then sent to the receiver circuit of the electronic device through the transmitter circuit in a wireless manner. The receiver circuit at last converts the AC signal into electric power for charging. Thereby, at least one electronic product can be charged simultaneously without using different dedicated chargers. Also the limitation caused to the practical use of the notebook by wired charging through a charger can be eliminated, in turn improving the convenience in use.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic perspective view of an adapter capable of wireless charging according to a first embodiment of the present invention;

FIG. 2 is a cross-sectional view of the adapter capable of wireless charging according to the first embodiment of the present invention;

FIG. 3 is an applied view of the adapter capable of wireless charging according to the first embodiment of the present invention;

FIG. 4 is a block diagram illustrating the configuration of the adapter capable of wireless charging according to the first embodiment of the present invention;

FIG. 5 is a schematic perspective view of an adapter capable of wireless charging according to a second embodiment of the present invention, wherein the adapter is unfolded;

FIG. 6 is a schematic perspective view of the adapter capable of wireless charging according to the second embodiment of the present invention, wherein the adapter is folded;

FIG. 7 is an applied view of the adapter capable of wireless charging according to the second embodiment of the present invention;

FIG. 8 is a schematic perspective view of an adapter capable of wireless charging according to a third embodiment of the present invention, wherein the adapter is unfolded;

FIG. 9 is a schematic perspective view of the adapter capable of wireless charging according to the third embodiment of the present invention, wherein the adapter is folded.

### DETAILED DESCRIPTION OF THE INVENTION

### First Embodiment

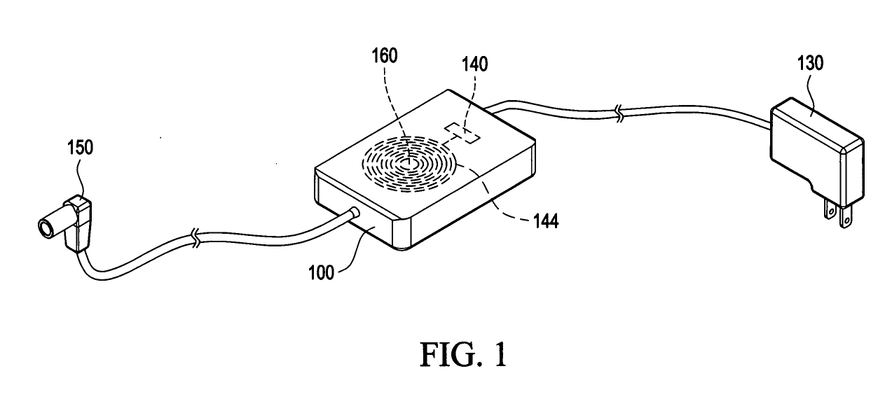

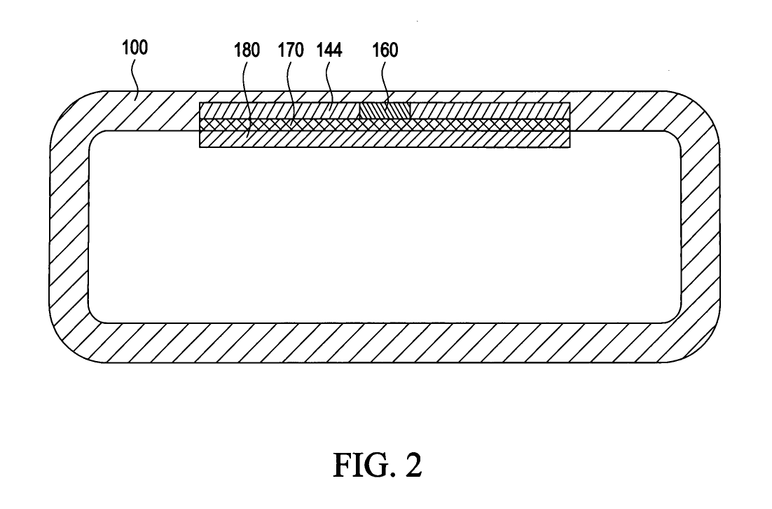

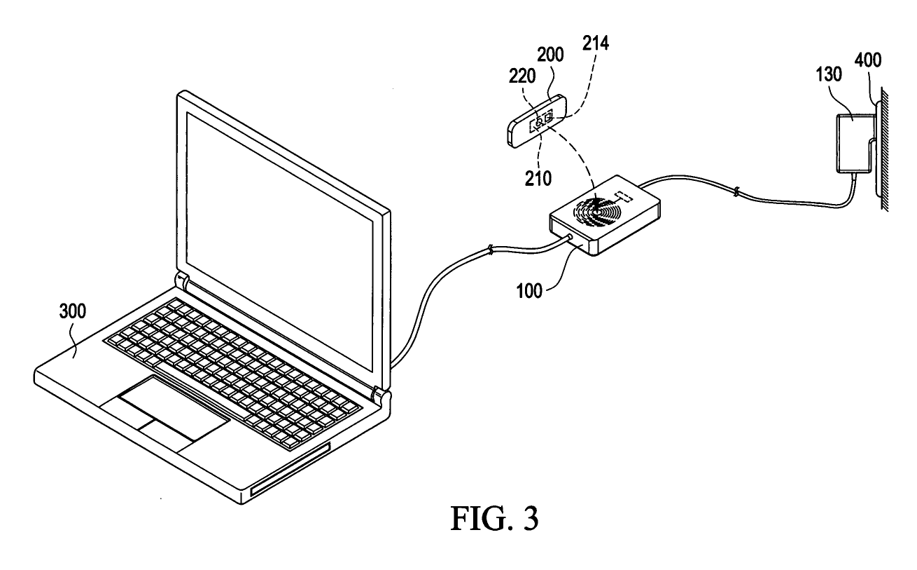

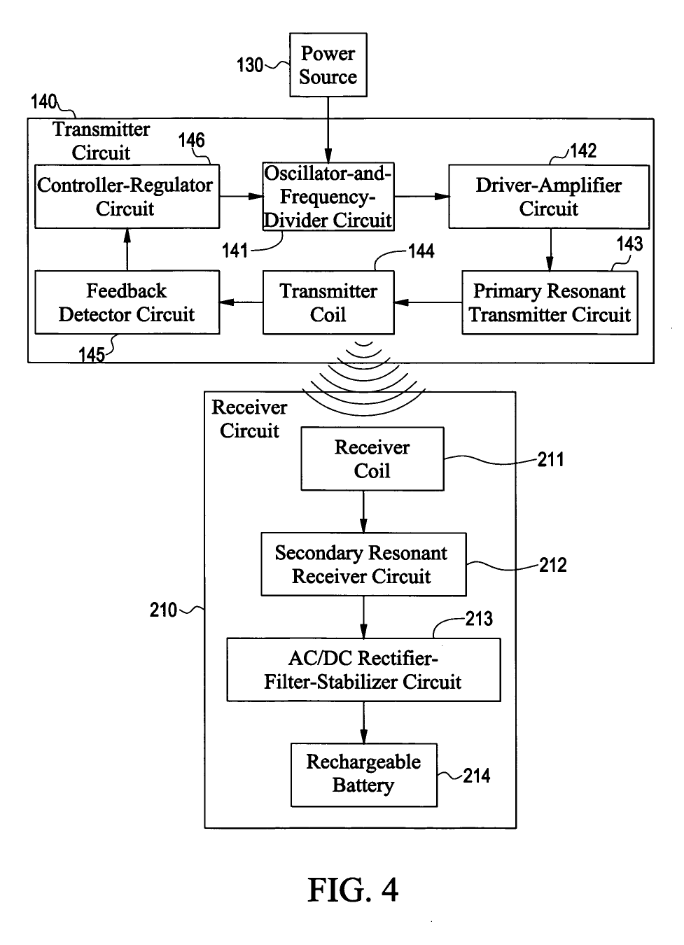

Referring to FIGS. 1 through 4, an adapter capable of wireless charging according to a first embodiment of the present invention is depicted in a schematic perspective view, an a cross-sectional view, an applied view and a block diagram. The adapter capable of wireless charging has a main body 100 provided with a transmitter circuit 140. A user may place an electronic device 200 that has a receiver circuit 210 on the main body 100 at will, for allowing charging in a wireless manner.

The main body 100 is the adapter and comprises a connector 150, a magnetic member 160, a magnetically permeable member 170 and a heat-dissipation member 180. The magnetic member 160 is deposited at one side of the main body 100, and the magnetically permeable member 170 is located between the magnetic member 160 and the heat-dissipation member 180. The main body 100 has at least one said transmitter circuit 140, so that electric power supplied by a power source 130 is received by the transmitter circuit 140 and converted into the AC signal. The AC signal is then sent to the receiver circuit 210 of the electronic device 200 in a wireless manner through the transmitter circuit 140, so that the receiver circuit 210 converts the AC signal into electric power to be stored and supplied to the electronic device 200.

The transmitter circuit 140 has an oscillator-and-frequency-divider circuit 141 connected to the power source 130, a driver-amplifier circuit 142 connected to the oscillator-and-frequency-divider circuit 141, a primary resonant transmitter circuit 143 connected to the driver-amplifier circuit 142 and a transmitter coil 144 connected to the primary resonant transmitter circuit 143. The oscillator-and-frequency-divider circuit 141 thus converts the electric power provided by the power source 130 into the AC signal. The AC signal is amplified by the driver-amplifier circuit 142, and the primary resonant transmitter circuit 143 resonates the amplified AC signal. Then the transmitter coil 144 sends the resonated AC signal to the receiver circuit 210. Therein, the AC signal may be collected by the magnetically permeable member 170 before sent out, while the heat-dissipation member 180 serves to dissipate heat generated by the main body 100 during its operation.

In addition, the transmitter circuit 140 may also include a feedback detector circuit 145 connected to the transmitter coil 144 and a controller-regulator circuit 146 connected to the feedback detector circuit 145 and the oscillator-and-frequency-divider circuit 141. The feedback detector circuit 145 feeds the AC signal coming from the transmitter coil 144 back to the controller-regulator circuit 146, so as to make the controller-regulator circuit 146 adjust an oscillation frequency of the oscillator-and-frequency-divider circuit 141, thereby optimizing the resonance.

The electronic device 200 may be a portable electronic product, such as a multimedia player or a mobile phone. The electronic device 200 may be positioned with respect to the main body 100 by means of wedge positioning (where, for example, the electronic device 200 and the main body 100 have a wedge and a mating socket, respectively), magnetic mooring (where, for example, the main body 100 and the electronic device 200 have their facing magnetic members with mutually attractive poles), acoustics positioning (where, for example, the main body 100 and the electronic device 200 have mating sound sensors) or light positioning (where, for example, the main body 100 and the electronic device 200 have mating light sensors). The receiver circuit 210 on the electronic device 200 comprises a receiver coil 211, a secondary resonant receiver circuit 212 connected to the receiver coil 211, an AC/DC rectifier-filter-stabilizer circuit 213 connected to the secondary resonant receiver circuit 212 and a rechargeable battery 214 connected to the AC/DC rectifier-filter-stabilizer circuit 213. Thereby, the receiver coil 211 receives the AC signal from the transmitter circuit 140. The secondary resonant receiver circuit 212 resonates the AC signal. The AC/DC rectifier-filter-stabilizer circuit 213 then rectifies and stabilizes the AC signal, so as to convert the AC signal into electric power. The electric power is stored in the rechargeable battery 214 before supplied to the electronic device 200.

In the present embodiment, the main body 100 is an adapter for a notebook (NB). The main body 100 has a transmitter circuit 140, a magnetic member 160 (such as a magnet), a magnetically permeable member 170 and a heat-dissipation member 180. In addition, the main body 100 has its two ends connected to the power source 130 and the connector 150. The main body 100 is electrically connected to a notebook 300 through the connector 150. To charge the electronic device 200 (such as a multimedia player or a mobile phone) with the magnetic member 220, positioning between the electronic device 200 and the main body 100 is facilitated by the mutually attractive magnetic member 220 of the electronic device 200 and the magnetic member 160 of the main body 100, and the power source 130 is coupled with a power outlet 400, so that the electric power provided by the power source 130 to the transmitter circuit 140 is converted into the AC signal by the transmitter circuit 140. Then the transmitter coil 144 of the transmitter circuit 140 sends the AC signal to the receiver circuit 210 of each said electronic device 200, thereby charging the receiver circuit 210, and in turn powering the electronic device 200. Thereby, at least one electronic product can be charged simultaneously without using its dedicated charger. Also the limitation caused to the practical use of the notebook by wired charging through a charger can be eliminated, in turn improving the convenience in use.

### Second Embodiment

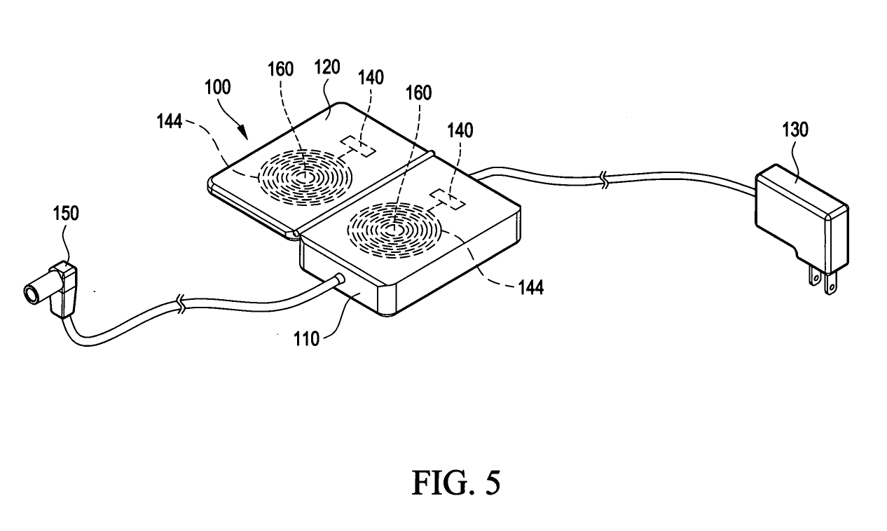

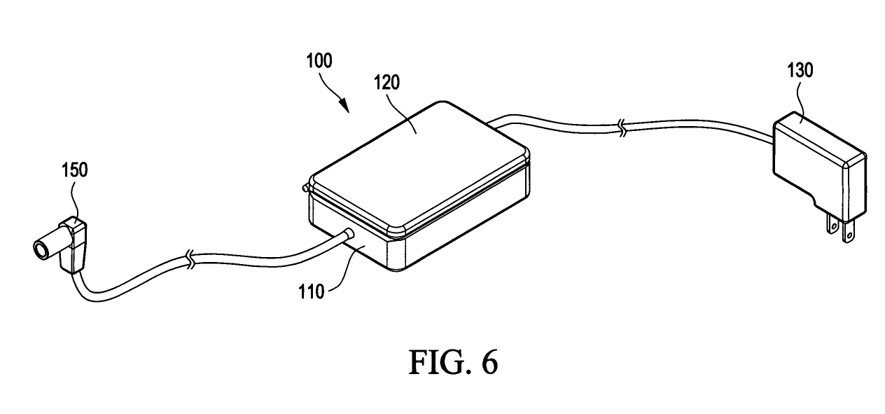

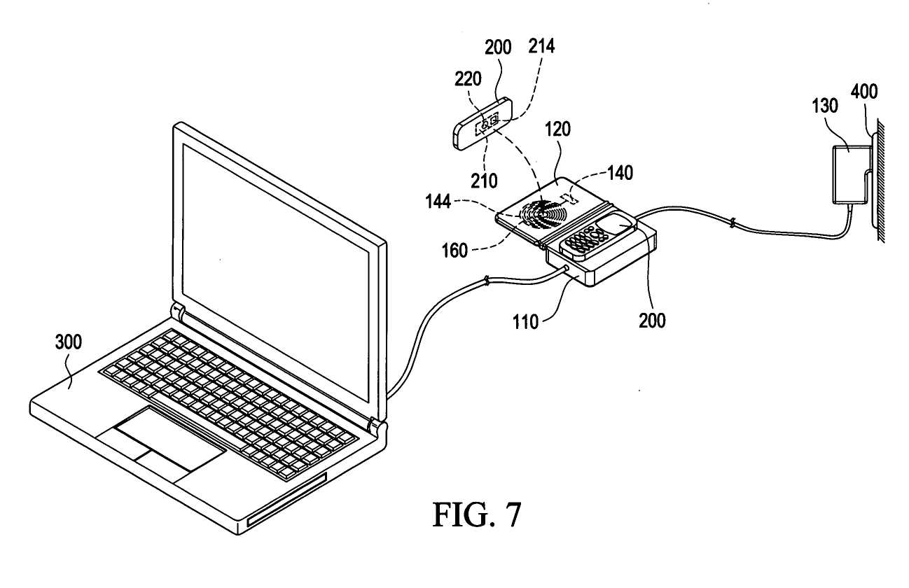

Referring to FIGS. 5 through 7, an adapter capable of wireless charging according to a second embodiment of the present invention is depicted in schematic perspective views and an applied view. The present embodiment is similar to the first embodiment, except that the main body 100 comprises a seat 110 and a cover 120. The cover 120 is attached to a lateral of the seat 110 so that the cover 120 is moveable or pivotable with respect to the seat 110. Particularly, when the cover 120 moves or pivots away from the seat 110, the adapter is posed unfolded (as shown in FIG. 5), so that the electronic device 200 can be placed on the seat 110 or the cover 120. In other words, the electronic device 200 may be positioned on the seat 110 alone, or on the cover 120 alone, or alternatively, two or more said electronic devices 200 may be positioned on the seat 110 and the cover 120, respectively. When the cover 120 moves or pivots toward the seat 110 to the end, the cover 120 coincides with the seat 110 (as shown in FIG. 6).

In the present embodiment, the cover 120 is pivotally connected to the lateral of the seat 110, so that the cover 120 can be pivoted away from the seat 110 in order to unfold the adapter, so that two electronic devices 200 can be positioned on the seat 110 and the cover 120, respectively, and get charged easily. When not used for charging, the adapter may be folded by pivoting the cover 120 toward the seat 110, so that the cover 120 and the seat 110 coincide with each other. As the adapter can be folded when carried and unfolded when used, it is conveniently portable and storable.

### Third Embodiment

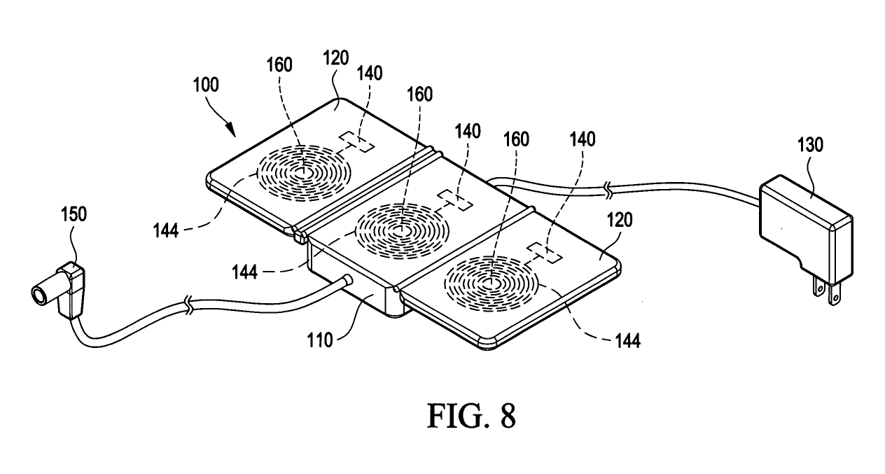

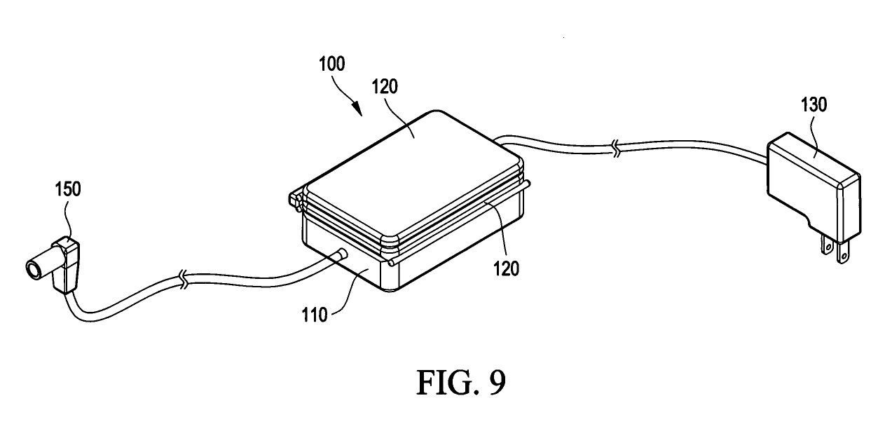

Referring to FIG. 8 and FIG. 9, an adapter capable of wireless charging according to a third embodiment of the present invention is depicted in schematic perspective views. The present embodiment is similar to the second embodiment, except that the main body 100 is composed of one seat 110 and two covers 120. The two covers 120 are attached to laterals of the seat 110 so that the covers 120 can be moved or pivoted away from the seat 110 in order to unfold the adapter, so that at least two electronic devices 200 can be positioned on the seat 110 and the covers 120, respectively, and get charged easily. When not used for charging, the adapter may be folded by pivoting the covers 120 toward the seat 110, so that the covers 120 close upon the seat 110. As the adapter can be folded when carried and unfolded when used, it is conveniently portable and storable.

To sum up, the adapter capable of wireless charging as disclosed may have the transmitter circuit 140 deposited at any portion of its main body 100. When a user wants to charge an electronic device 200 with a receiver circuit 210, the user may position the electronic device 200 on the main body 100, so that the transmitter circuit 140 can send an AC signal to the receiver circuit 210 in a wireless manner, thereby charging the receiver circuit 210, so that electric power can be stored and provided to the electronic device 200. Thereby, at least one electronic product can be charged without using its dedicated charger. Also the limitation caused to the practical use of the notebook by wired charging through a charger can be eliminated, in turn improving the convenience in use.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An adapter capable of wireless charging for coupling and charging at least one electronic device, the electronic device having a receiver circuit, and the adapter capable of wireless charging comprising:
a main body being coupled with the electronic device, wherein the main body is the adapter and includes a power source; and
at least one transmitter circuit deposited on the main body, the power source providing electric power to the transmitter circuit, the electric power being converted into the AC signal by the transmitter circuit, the AC signal being sent to the receiver circuit of the electronic device through the transmitter circuit in a wireless way, and the receiver circuit converting the AC signal into electric power for charging the electronic device.

2. The adapter capable of wireless charging as claimed in claim 1, wherein the main body comprises a seat and at least one cover, the power source being connected to the seat, the cover being connected to a lateral of the seat, and the transmitter circuit being deposited on one of the seat or the cover.

3. The adapter capable of wireless charging as claimed in claim 2, wherein the electronic device is coupled with one of the seat or the cover.

4. The adapter capable of wireless charging as claimed in claim 2, wherein the cover is pivotally connected to the lateral of the seat.

5. The adapter capable of wireless charging as claimed in claim 1, wherein the main body and the electronic device are coupled by means of wedge positioning, magnetic mooring, acoustics positioning or light positioning.

6. The adapter capable of wireless charging as claimed in claim 5, wherein the main body and the electronic device are coupled by means of the magnetic mooring, the main body having a magnetic member, a magnetically permeable member and heat-dissipation member, and the magnetically permeable member being located between the magnetic member and the heat-dissipation member.

7. The adapter capable of wireless charging as claimed in claim 1, wherein the transmitter circuit comprises an oscillator-and-frequency-divider circuit, driver-amplifier circuit, a primary resonant transmitter circuit and a transmitter coil, the oscillator-and-frequency-divider circuit being connected to the power source and configured to convert the electric power provided by the power source into the AC signal, the driver-amplifier circuit being connected to the oscillator-and-frequency-divider circuit and configured to amplify the AC signal converted by the oscillator-and-frequency-divider circuit, the primary resonant transmitter circuit being connected to the driver-amplifier circuit and configured to resonate the AC signal amplified by the driver-amplifier circuit, the transmitter coil being connected to the primary resonant transmitter circuit and configured to send the resonated AC signal coming from the primary resonant transmitter circuit to the receiver circuit.

8. The adapter capable of wireless charging as claimed in claim 7, wherein the transmitter circuit further comprises a feedback detector circuit and a controller-regulator circuit, the feedback detector circuit being connected to the transmitter coil, the controller-regulator circuit connected to the feedback detector circuit and the oscillator-and-frequency-divider circuit, the feedback detector circuit feeding the AC signal coming from the transmitter coil back to the controller-regulator circuit, and the controller-regulator circuit adjusting an oscillation frequency of the oscillator-and-frequency-divider circuit.

9. The adapter capable of wireless charging as claimed in claim 1, wherein the receiver circuit comprises a receiver coil, a secondary resonant receiver circuit, an AC/DC rectifier-filter-stabilizer circuit and a rechargeable battery, the receiver coil receiving the AC signal coming from the transmitter circuit, the secondary resonant receiver circuit being connected to the receiver coil and configured to resonate the AC signal received by the receiver coil, the AC/DC rectifier-filter-stabilizer circuit connected to the secondary resonant receiver circuit and configured to rectify and stabilize the resonated AC signal coming from the secondary resonant receiver circuit and convert the AC signal into electric power, the AC/DC rectifier-filter-stabilizer circuit being connected to the rechargeable battery, and the rechargeable battery storing the electric power converted by the AC/DC rectifier-filter-stabilizer circuit.
